(19) United States
(12) Patent Application Publication
(10) Pub. No.: US 2019/0071327 A1
(43) Pub. Date: Mar. 7, 2019

(54) DEVICE AND METHOD FOR TREATING AND FILLING WATER

(71) Applicant: Krones AG, Neutraubling (DE)

(72) Inventors: Roland FEILNER, Regensburg (DE); Thomas OEHMICHEN, Regensburg (DE); Torsten RUNGE, Straubing (DE); Stefan HOELLER, Thalmassing (DE); Martin KELLER, Abensberg (DE)

(21) Appl. No.: 15/842,745

(22) Filed: Dec. 14, 2017

(30) Foreign Application Priority Data
Sep. 4, 2017 (DE) 10 2017 215 447.0

(51) Int. Cl. C02F 1/44; B01D 61/02; B01D 61/12; B01D 61/08; B01D 61/18; C02F 1/00

(52) U.S. Cl. CPC C02F 1/441; B01D 61/025; B01D 61/12; B01D 61/08; C02F 2303/16; C02F 1/008; C02F 2209/42; C02F 2209/05; B01D 61/18

(57) ABSTRACT

Embodiments of the invention relate to a device for treating and filling water, comprising: a water treatment device with at least one filtration module, at least one filling device for filling water, in particular, for filling containers with water treated by the water treatment device, and wherein the water treatment device is coupled directly to the filling device.

### RELATED APPLICATIONS

This patent application claims the benefit under 35 U.S.C. § 119(a) of German patent application no. 102017215447.0, filed Sep. 4, 2017, which is incorporated by reference herein.

### TECHNICAL FIELD

The invention relates to a device and method for treating and filling.

### BACKGROUND

It is customary when processing water in the food and beverage industry to subject the water to be processed to various filtration and sterilization methods in order to be able to comply with the special hygienic requirements of the food and beverage industry.

Conventional systems and devices for performing filtration and sterilization methods for water can sometimes be very complicated and complex.

In addition, conventional devices and methods for treating and filling water can bear undesirable additional health risks.

For example, in the context of conventional sterilization methods using ozone, potentially carcinogenic by-products, such as, for example bromates, can be formed by the oxidation of water containing bromide.

It is also common to often treat water centrally, buffer it and then distribute it to a varying number of fillers. This buffering and distribution entails the risk of recontamination. This risk must be minimized by appropriate processes and safety precautions.

### BRIEF DESCRIPTION OF THE DRAWINGS

Embodiments of the present invention are illustrated by way of example, and not by way of limitation, in the figures of the accompanying drawings.

FIG. 1a illustrates an example of a device for treating and filling water.

FIG. 1b illustrates a further example of a device for treating and filling water.

### DETAILED DESCRIPTION

It is an object of an embodiment of the invention to improve a device and a method for treating and filling water, for example, in particular with regard to hygiene, the footprint, health safety, cost-effectiveness and/or efficiency.

This is satisfied by embodiments of the invention with a device according to claim 1 and a method according to claim 8.

Advantageous embodiments and further developments are the subject matter of the dependent claims.

A device according to embodiments of the invention for treating and filling of water, for example, for filling water in containers, e.g. bottles, as part of a bottling system can comprise, for example, the following components or modules, respectively:
at least one water treatment device with at least one filtration module, as well as
at least one filling device for filling, in particular, for filling containers with water treated by the water treatment device.

The device for treating and filling water can be configured or designed such that the water treatment device can be coupled directly to the filling device.

The exemplary direct coupling of the water treatment device to the filling device can be understood as meaning, in particular, that, no intermediate storage or relief storage or decoupling storage in which treated water could be temporarily stored before being supplied to the filling device is arranged between the water treatment device and the filling device.

In other words, the water treatment device and the filling device are directly connected to each other, so that water from the water treatment device, i.e. water treated by the water treatment device, can flow directly and without detour into the filling device where it can be filled directly into containers.

The path of treated water from the water treatment device, or the path from the last module of the water treatment device, respectively, e.g. a (single or last) filtration module and/or a (single or last) reverse osmosis module, to the filling device can therefore be without any intermediate modules or components such as valves or pumps. It is to be noted, however, that it can be possible that supply lines and/or discharge lines for the supply or discharge of cleaning liquids and/or additional discharge lines for the treated water can be provided between the one/the last module of the water treatment device and the filling device, e.g. in order to be able drain to the gully at short notice.

The present invention in embodiments makes it possible to dispense with, inter alia, conventional special intermediate storage or relief storage or decoupling storage or buffer storage for treated water that are arranged between a filling device and a water treatment device.

The device can therefore be designed, for example, in a more compact and less complex manner than conventional devices.

In particular, the length of the flow paths or the distances between the water treatment device and the filling system can be reduced or minimized as compared to conventional systems.

This possible reduction of the required flow paths or routes which must be traveled by the treated water within the device leads, in particular, to the effect that recontamination with germs can be prevented or reduced and a sterile or aseptic operating environment or sterile or aseptic handling of the treated water to be filled can be achieved, respectively, because, for example, the treated water can spend less time in the device for treating and filling water, and the water within the device is less or not at all stagnant and can be in less contact with components of the device.

For example, conventional elaborate measures for sterilizing the water, such as a treatment with ozone and/or ultraviolet radiation (UV) and/or chlorine and/or chlorine dioxide, can be dispensed with. For example, and in particular due to possibly dispensing with ozone water treatment, the formation of hazardous bromates, that can have a carcinogenic effect and can form from ozone and bromine dissolved in the water, can be prevented. It has previously been assumed that it can be ensured only with a complex sterilization of the treated water that the water can be filled in a sterile manner.

The flow paths for the treated water or the water to be filled within the filling device, respectively, can serve as intermediate buffers for the treated water or the water to be filled.

For example, the filling device can comprise an intermediate buffer, e.g. in the form of an annular or ring chamber or a ring line, or an annular tank or a ring bowl, for intermediate buffering of water supplied from the water treatment device, by way of which e.g. individual filling valves of the filling device can be supplied.

For example, the filling device or the filling machine, respectively, can in particular have severally filling stations at which containers can be filled with water, and where the water to be filled can be distributed via a ring chamber or a ring line or a ring bowl to the various filling stations.

For example, the ring chamber or the ring line or the ring bowl can be arranged above the filling stations. This enables a particularly space-saving device. In particular, the filling level in the ring chamber or the ring line or the ring bowl can be above the possible filling stations of the filling device.

Said exemplary ring chamber or ring line or respectively exemplary ring bowl of the filling device can then serve as an intermediate buffer or intermediate storage for the treated water that is supplied form the water treatment device and to be filled.

For example, the possible intermediate buffer of the filling device or the possible direct supply and/or discharge lines for water of the intermediate buffer can be provided or equipped with apparatuses known from prior art for carbonating the water.

Said exemplary at least one filtration module can be configured, for example, to perform a membrane separation method or membrane filtration of water, respectively, or of water or raw water supplied to the water treatment device, respectively.

For example, the filtration module or a plurality of filtration modules can be configured to perform microfiltration and/or ultrafiltration and/or nanofiltration of the water to be treated. Said exemplary filtration options can enable providing sterile or aseptic water for the filling device.

For example, undesired particles, viruses or spores up to a size of 0.02 microns can be removed by ultrafiltration from the water to be treated or from the raw water, or, for example, germ counts of less than one germ per ten 1-liter containers can be obtained.

However, it is also possible to use other filtration methods in the filtration module(s).

The water treatment device can also comprise, for example, a plurality of filtration modules, where the filtration modules are operable independently of each other, or can be operated or controlled individually or in groups, respectively.

Depending on the operating situation or operating demands, respectively, this can enable, for example, varying the capacity of the device, e.g. by switching on or off individual filtration modules in order to avoid, for example, inter alia, an overflow or bottleneck of water to be filled at the filling device.

In addition, the device or the water treatment device, respectively, can be configured such that some of the filtration modules can be cleaned and/or backflushed during operation of the device, if the device disposes of e.g. a plurality of filtration modules, meaning that cleaning or backflushing of filtration modules can take place during operation of the device. In other words, e.g. some of the filtration modules can perform filtering during the operation of the device or the water treatment device, respectively, while some others can be cleaned. Incidentally, the filling device can comprise at least one filling level gauge or filling level sensor, respectively, which can be configured to measure a filling level of water in the filling device, or can be configured to measure how much water has been filled via the filling device. Said possible exemplary filling level gauge or filling level sensor, respectively, can comprise inter alia a quantity measuring device for more accurate measurement of the quantity filled and/or, for example, be connected to possible quantity measuring devices in lines of the filling device.

The device for treating and filling water can be configured to control the water treatment device in dependence of the measurements of the filling level sensor and, for example, control the water treatment device or the filtration modules, respectively, depending on the measured filling level of water in the filling device, or regulate the capacity of the water treatment device, e.g. by regulating the raw water inflow or by switching on or off individual filtration modules, such that, for example, either more or less water is treated or more or less treated water can be provided to the filling device or supplied to the filling device, respectively.

Fluctuations in the water quantities demanded by the filling device can thus be accounted for.

Due to its variability and its design, the device for treating and filling water presently described by way of example can enable a hygienic production which can be optimally adapted to a changing demand capacity of the filling device.

In other words, the exemplary water treatment and filling device can enable hygienic just-in-time production synchronized with demand.

The device for treating and filling water can thereby also be configured such that excess water can be returned to the water treatment device, e.g. via a return line, in the event of the filling device being overfilled. An aseptic shut-off valve can be provided in an advantageous manner in the return line. For example, it can be an aseptic non-return valve in combination with an aseptic shut-off valve. It can then be prevented, for example, that raw water reaches the side of the treated water and contaminates it.

In addition, the water treatment device can comprise at least one reverse osmosis module which can be configured to perform reverse osmosis.

This exemplary optional reverse osmosis module can be arranged, for example, downstream of the filtration module(s) and, for example, serve to regulate the salinity of the water to be treated, for example, in order to be able to regulate, inter alia, the electrical conductivity or the conductance of the water.

However, it is also conceivable that said at least one exemplary optional reverse osmosis module can also be upstream of a/the filtration module(s), i.e. at least one reverse osmosis process can be performed upstream of a filtration process by a filtration module.

It is also conceivable that said at least one exemplary optional reverse osmosis module can be arranged parallel to a/the filtration module(s) In this case, e.g. raw water can be supplied to said at least one exemplary optional reverse osmosis module independent of a/the raw water supply to the filtration module or independent of the raw water supply by the filtration modules.

The water or raw water, respectively, passed or filtered through the filtration module(s) can then be mixed, for example, with water or raw water that has passed through said optional reverse osmosis module, before the water mixed or blended in this manner can be passed on to the filling device.

For the sake of completeness it should be mentioned that all components, in particular, e.g. water lines, of the device can be configured to be hygienic or aseptic or can be operated in a hygienic working environment, respectively, to ensure a high standard of hygiene.

In particular, the device for treating and filling water, in particular the water treatment device, can be configured such that the components and modules, e.g. the filtration modules, can be cleaned by backflushing.

The exemplary device for treating and filling water or the water treatment device presently described, respectively, can in particular have a block-like structure which can comprise a plurality of modules, for example, filtration modules and/or reverse osmosis modules, which can be operated individually and/or in groups and can be switched on and off individually and/or in groups.

Also, for example, several filtration modules, if present, can be combined to form a filtration block or filtration blocks.

For example, individual and/or group-wise control of possible pumping capacities of said modules can also be effected.

Moreover, the device for treating and filling water or the water treatment device, respectively, can also be configured in such a way that individual components and modules, e.g. individual filtration modules, can be cleaned separately and independently, e.g. by backflushing, so that cleaning during production operation is possible, meaning that a continuous production operation can be enabled. For example, cleaning by backflushing can be performed in particular when the filling device is stops filling.

For example, those filtration modules can be cleaned, e.g. which are switched off or shut down during the ongoing operating situation or are in a cleaning mode, respectively, while other filtration modules can be in a production mode of operation, thereby ensuring the continuous production operation of the device for treating and filling water.

The exemplary device for treating and filling water presently described or the exemplary water treatment device described, respectively, can comprise at least one connection to a raw water supply, via which the device or the water treatment device, respectively, can be supplied with water to be treated.

Said possible exemplary raw water supply connection can comprise a valve, e.g. a shut-off valve, in order to be able to regulate the raw water supply, e.g. to be able to interrupt the supply of raw water.

However, it is also conceivable that the exemplary device for treating and filling water presently described or the exemplary water treatment device described, respectively, can comprise several raw water supplies or several connections to a raw water supply in order to be able to supply, for example, various modules, such as individual filtration modules and/or reverse osmosis modules, individually or in groups with raw water.

The exemplary possible modules of the water treatment device, i.e. the filtration modules and the reverse osmosis modules, respectively, can also be downstream of valves, e.g. shut-off valves, for example, arranged at the inlets of the respective modules to regulate the operation of the modules or the supply of water to be treated at the respective modules and, e.g. to be able to interrupt it when necessary.

An exemplary method for treating and filling water can comprise one, several, or all of the following exemplary steps:
treating water in a water treatment device with at least one filtration module,
passing water treated by the water treatment device directly to a filling device for filling, in particular, containers.

The at least one filtration module or a plurality of filtration modules can perform microfiltration and/or ultrafiltration and/or nanofiltration of the water to be treated, and/or the water treatment device can perform reverse osmosis of the water to be treated, before the treated water is passed directly to the filling device.

In other words, the path between the water treatment device or the (only or last) filtration module and the filling device can be minimized, and the path can be free of any valves or intermediate storage devices for intermediate storing of treated or filtered water, respectively, so that a direct coupling between the water treatment device and the filling device can be realized. This makes it possible to prevent, in particular, for example, membranes of the filtration modules from being damaged by pumps or fittings being switched on or off, e.g. due to pressure surges.

Said exemplary optional reverse osmosis can be performed, for example, in particular downstream of the water passing the filtration module(s) and, for example, serve to regulate the salinity of the water to be treated, for example, in order to be able to regulate inter alia the electrical conductivity or the conductance of the water.

In this case, the electrical conductivity or the conductance of the water can be measured or indicated, for example, in microsiemens (μS) or microsiemens per centimeter (μS/cm).

Said conductance or said electrical conductivity of the water can be measured before, during and after the treatment by the water treatment device.

Prior to being passed on, for example, the water passing through optional reverse osmosis can be mixed variably, e.g. in relation to a prescription of a conductance value, with water that has previously passed through different filtration modules.

It is therefore conceivable, for example, that the water treatment device is able to perform at least one reverse osmosis process for the water to be treated and to perform at least one microfiltration and/or ultrafiltration and/or nanofiltration process of the water to be treated and, depending on a predefinable conductance value of the water to be filled, that the water filtered e.g. by microfiltration and/or ultrafiltration and/or nanofiltration can be mixed with water from the at least one reverse osmosis process before the treated water can be passed directly to the filling device.

The device for treating and filling water or the water treatment device, respectively, can comprise e.g. a control unit which can be configured to control and regulate the flow paths and/or mixing ratios and/or performance, e.g. filtration performance and/or pumping capacity of individual modules, for example, in dependence of a sensor for measuring the conductance of water in the water treatment device and/or in dependence of a sensor, e.g. filling level gauge, for measuring a filling level of the filling device.

The possible exemplary at least one reverse osmosis process can be performed, inter alia, in a circulation method in order not to impair or interrupt the operation of the reverse osmosis process.

The optional reverse osmosis can be performed in/with a controllable bypass. In other words, the water treatment device can be configured such that, optionally, reverse osmosis can be performed or not in a possible reverse osmosis module, for example, in dependence of a predetermined conductance value of the water, i.e. an exemplary possible reverse osmosis module can either be switched into a flow path of the water treatment device or be bypassed via a flow path bypass.

This can enable or facilitate e.g. direct blending or mixing of water from microfiltration and/or water from ultrafiltration and/or water from nanofiltration with reverse osmosis water.

In addition, e.g. a filling level or a filling height of the filling device can be determined, where individual components of the water treatment device, for example, individual filtration modules and/or individual reverse osmosis modules can be switched off and/or switched on and/or controlled in dependence of the specific filling level or the specific filling height of the filling device, for example, to enable production synchronized with or adapted to demand.

The performance of the water treatment device or the filtration, respectively, can therefore be varied by partially switching off and/or on components, e.g. in order to be able to react to fluctuating demand capacities of the filling device, as well as for the purpose of backflushing individual modules for intermediate cleaning of the modules, e.g. filtration modules, even during operation of the device for treating and filling.

In the possible event that the filling device is overfilled or in the event of a filling stop or a filler stop, respectively, excess water or water not extracted by the filling device can be returned to the water treatment device.

For example, the excess water or the water not extracted by the filling device can be passed back into a filtration module, for example, into the inlet of a membrane of a filtration module. In other words, water already treated can again be supplied to/subjected to treatment by the water treatment device.

For example, at least a portion of returned excess water can be used for backflushing filtration modules and/or generally a portion of the treated water can be returned for cleaning or backflushing filtration modules.

Alternatively or additionally, the raw water supply to the device can also be interrupted in the event that the filling device is overfilled or in the event of a filling stop or during a filler stop.

These exemplary measures, when the filling device is overfilled or in the event of a filling stop, can serve to maintain constant the operating conditions in a filtration module/in the filtration modules, e.g. the operating conditions for a membrane of a filtration module.

For example, in the event of a filling stop at the filling device, for example, the filling interruption can be used to regenerate or to clean the filtration module(s) and any other modules, such as e.g. a reverse osmosis module, of the water treatment device, e.g. by backflushing.

In the event of a filling stop at the filling device, for example, only permeate can be returned into a filtration module (for example, for microfiltration and/or ultrafiltration and/or nanofiltration), and/or, in the case of a possibly existing reverse osmosis module/reverse osmosis step, only permeate can be returned into a reverse osmosis module.

It is conceivable that retentate can also be returned into a filtration module (for example for microfiltration and/or ultrafiltration and/or nanofiltration), and/or in the case of a possibly existing reverse osmosis module/reverse osmosis step, both permeate and retentate can be returned into a reverse osmosis module.

Prior to commissioning the device for treating and filling water, the integrity of the device, or the integrity of individual, some or all of the modules, i.e. the filtration module (s) and/or the reverse osmosis module (s), of the water treatment device can be tested, for example, by pressurization, where, for example, it is measured how rapidly pressure that has built up or been applied reduces.

During the production operation of the device, integrity tests or quality tests can be performed alternatively or additionally at an outlet of a filtration module, e.g. at the outlet of a membrane of a filtration module, for example, by way of potable water analysis methods and/or by way of tracer addition, and examinations to detect certain relevant germs can be performed.

The exemplary modular configuration of the device for treating and filling water or the water treatment device. respectively, can inter alia enable that said exemplary integrity tests or quality tests be performed for each individual module, e.g. each filtration module and/or each reverse osmosis module.

For example, if a defect, e.g. a diaphragm rupture, is detected in a module, only the respectively affected defective module needs to be shut down and not the entire system or the entire water treatment device or the entire device for treating and filling water, respectively.

For example, during an exchange and/or when one module is switched off and/or shut down, the device, i.e. the water treatment device or the entire device for treating and filling water, respectively, can be operated at the same performance in that, e.g. the performance of the other modules is increased, or possibly continue operation at reduced performance. Downtime of the device can then be avoided or reduced.

The filling device can, in particular, be configured to be hygienic. For particularly high purity requirements, it can also can be configured to be aseptic.

The filling device can be integrated, inter alia, in a clean room. Furthermore, the filling device can be equipped with foam cleaning, UV-closure treatment and/or a neck sterilizer. Above exemplary possible embodiments can in particular further reduce the risk of recontamination.

It is additionally conceivable that smallest amounts of ozone can be passed into the filling device in the event that, for example, respective hygienic conditions are not ensured at the filling device. It can thereby, e.g. be ensured for this case that the filled and closed bottle is sterile.

In addition, the filling device can be provided, for example, with a blow-molding machine, e.g. for bottling PET bottles. The blow-molding machine can be configured to be hygienic, or also aseptic for particularly high purity requirements. Furthermore, the blow-molding machine can comprise an upstream hygienic preform feed.

For the sake of completeness, it is to be mentioned that an exemplary device according to embodiments of the invention for treating and filling water can be configured to perform individual, some or all of the exemplary method steps presently described for treating and filling water.

In summary, an exemplary device or an exemplary method can provide the following advantages over conventional technologies for treating and filling water:
Hygienic just-in-time production
Saving components, such as special additional intermediate storages or buffer tanks for intermediate storage of treated water
Omitting expensive and potentially hazardous measures, such as sterilization of water with ozone and/or UV radiation and/or treatment with chlorine or chlorine dioxide, avoidance of bromine formation
Reducing investment costs, better energy balance and better environmental compatibility, lower production losses and a lower system volume.

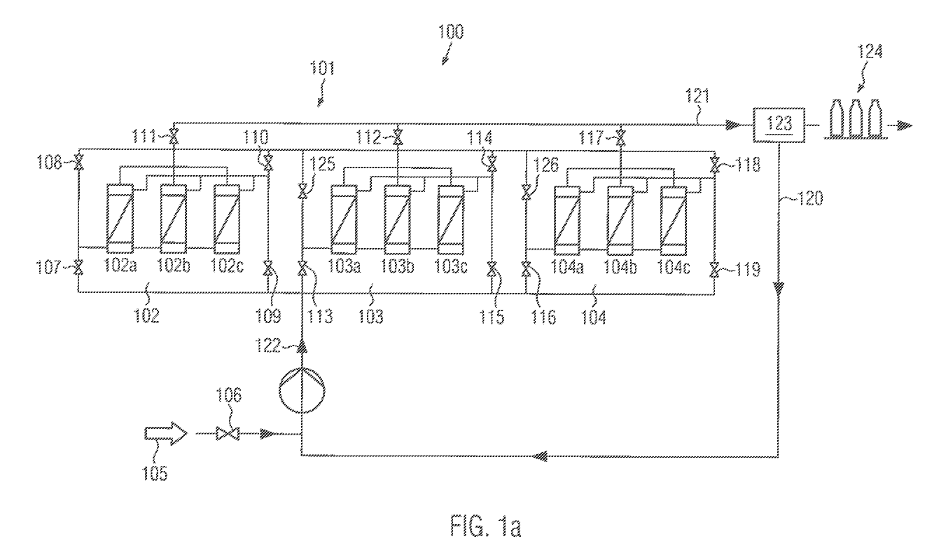

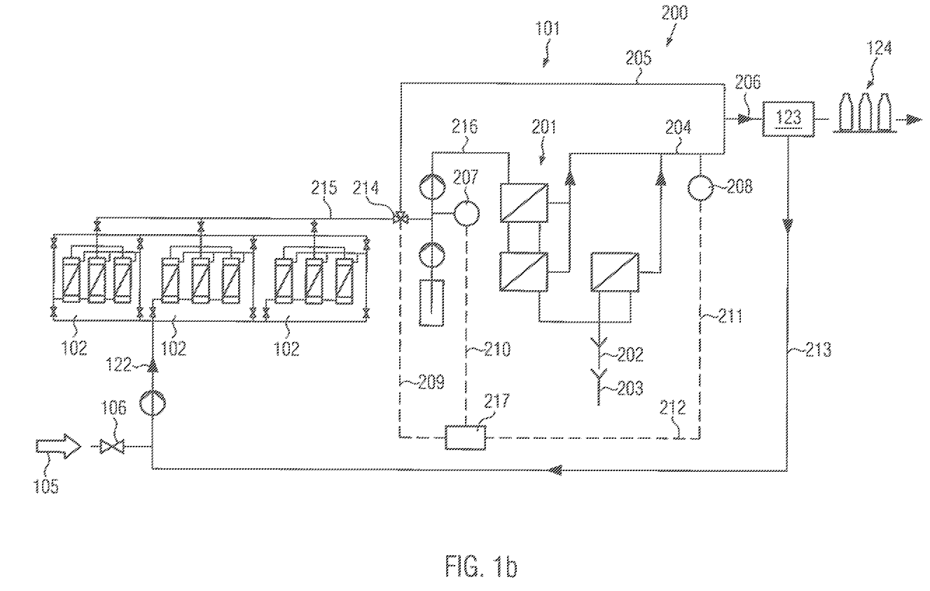

FIG. 1a, by way of example and schematically, shows a device 100 for treating and filling water.

Device 100 can comprise e.g. a water treatment device 101, as illustrated. The exemplary water treatment device can comprise, for example, several filtration modules 102a, 102b, 102c, 103a, 103b, 103c, 104a, 104b, 104c which can be configured e.g. to perform membrane filtration for microfiltration and/or ultra-filtration and/or nanofiltration. Said exemplary filtration modules are by way of example grouped into various blocks 102, 103, 104, wherein each exemplary filtration block comprises three filtration modules.

However, this number and the division is merely by way of example.

Device 100 comprises an exemplary connection 105 for raw water via which raw water, i.e. in particular untreated water, can be passed into device 100 and via an exemplary flow path 122 to exemplary filtration modules 102a, 102b, 102c, 103a, 103b, 103c, 104a, 104b, 104c, or to exemplary filtration blocks 102, 103, 104, respectively.

Exemplary connection 105 for raw water can be associated with a shut-off device, e.g. a shut-off valve, via which the supply of raw water into the device can be regulated, and the raw water supply can be interrupted, for example, in the event of problems or defects or e.g. when filling device 123 is overfilled or filling is stopped.

Filtration modules 102a, 102b, 102c, 103a, 103b, 103c, 104a, 104b, 104c or filtration blocks 102, 103, 104, respectively, can be supplied individually or in groups with raw water for filtering via respective exemplary flow paths (solid lines) and respective exemplary valves 107, 108, 109, 110, 111, 112, 113, 114, 115, 116, 117, 118, 119, 125, 126, exemplary multi-way valves, such as e.g. two-way valves or three-way valves.

The water treatment device can also dispose of a plurality of pumps (not shown).

The water treatment device or exemplary filtration modules 102a, 102b, 102c, 103a, 103b, 103c, 104a, 104b, 104c or filtration blocks 102, 103, 104, respectively, can also be configured such that said exemplary filtration modules or said exemplary filtration blocks, respectively, can be operated individually or in groups, so that the filtration performance of water treatment device 101 can be varied, for example, by varying the pumping capacity and/or by switching off or switching on individual filtration modules or filtration blocks, or by separating or adding individual filtration modules or filtration blocks to exemplary flow path 121 which can lead directly to exemplary filling device 123.

Water treatment device 101 is thereby connected via exemplary flow connection 121 directly to filling device 123. Device 100 or water treatment device 101, respectively, therefore comprises, in particular, no special intermediate storage for treated water or for permeate, respectively. For the exemplary case that filling device 123 cannot extract water via exemplary flow connection 121, e.g. due to an overfill or a filling stop, this not extracted water can be, for example, returned to the inlet of water treatment device 101, or to the inlets of the filtration modules or filtration blocks, respectively. In addition, exemplary containers 124 are shown which have been filled/can be filled by filling device 123.

FIG. 1b illustrates, by way of example and schematically, a further exemplary device 200 for treating and filling water, where device 200 can comprise some or all of the features of device 100, or is compatible with the features of device 100, respectively.

For example, device 200 can also comprise exemplary filtration modules 102a, 102b, 102c, 103a, 103b, 103c, 104a, 104b, 104c, or exemplary filtration blocks 102, 103, 104, as well as exemplary valves 107, 108, 109, 110, 111, 112, 113, 114, 115, 116, 117, 118, 119. For the sake of clarity, however, only reference numerals 102, 103, 104 are shown in FIG. 1b for the filtration blocks.

Like device 100, device 200 can also comprise an exemplary connection 105 for raw water, via which raw water, i.e. in particular untreated water, can be passed into device 200 and via an exemplary flow path 122 to the exemplary filtration modules or to exemplary filtration blocks 102, 103, 104, respectively.

In addition to exemplary filtration blocks 102, 103, 104 or exemplary filtration modules, respectively, the device can comprise at least one reverse osmosis module or respectively a reverse osmosis block 201 with at least one or a plurality of reverse osmosis modules.

Illustrated by way of example is a two-stage reverse osmosis block 201 which in the first stage can comprise two exemplary reverse osmosis modules connected in parallel, where e.g. the retentate of these two reverse osmosis modules can be supplied to a further third reverse osmosis module (in the second stage) to increase the yield. The permeate streams of the first and second stages can be combined and the retentate of the second stage or of the third reverse osmosis module, respectively, can be discharged into an exemplary gully 203.

Device 200 can there be configured such that water or raw water which has passed through individual, some or all filtration modules or through individual, some or all filtration blocks, respectively, can be passed via flow paths 215 and 205 directly to exemplary filling device 123.

Similarly to FIG. 1a, containers 124 filled by filling device 123 are shown by way of example.

The exemplary possible reverse osmosis by exemplary reverse osmosis block 201 or by an exemplary reverse osmosis module, respectively, can thus optionally be bypassed.

However, for example, the water or raw water, which has passed through individual, some or all filtration modules or through individual, some or all filtration blocks, respectively, i.e. which has already been filtered, can alternatively or additionally be passed via exemplary flow paths 215 and 216 into exemplary reverse osmosis block 201 or into an exemplary reverse osmosis module, respectively.

It can be e.g. controlled by an exemplary multi-way valve, e.g. a three-way valve 214, whether and/or how much water, which has previously passed through individual, some or all of the filtration modules, or through individual, some or all of the filtration blocks, is passed into reverse osmosis block 201.

Device 200 can also be configured such that the water that has passed through the exemplary reverse osmosis block is mixed with water that has passed through only individual, some, or all filtration modules, or individual, some, or all of the filtration blocks.

In other words, for example, flow path 204 for the water, which has been supplied to at least one reverse osmosis process, can be connected to flow path 205, for water which has passed only individual, some or all filtration modules, respectively, so that, for example, a mixture of water filtered by individual, some or all of the filtration modules, and water which has undergone reverse osmosis can be supplied to filling device 123.

The ratio of the proportions of water from the filtration modules and the proportions of water from the reverse osmosis block or the reverse osmosis module, respectively, in the exemplary optional mixture can be variable.

As described above, the use of a reverse osmosis method step can for instance be effected in dependence of a predetermined conductance value for the water to be filled. For this purpose, the device can comprise, for example, various sensors for measuring the conductance value, for example a first sensor 207 at the inlet of the reverse osmosis block or the reverse osmosis module, respectively, and a second sensor 208 at the outlet of the reverse osmosis block or the reverse osmosis module, respectively.

Depending on the specific conductance value or depending on the specification, for example, a control unit 217 can control or regulate the use of possible reverse osmosis by one/the exemplary reverse osmosis block or by a reverse osmosis module, respectively, via the exemplary communication connections 209, 210, 211 (shown in dashed lines) for control signals.

In analogy to device 100, device 200 can also be configured to return water not extracted by filling device 123, e.g. in the event that filling device 123 is overfilled or filling has stopped, into the inlet of water treatment device 101, or return it to the inlets of the filtration modules or filtration blocks, respectively.

For the sake of completeness, it is to be noted that the arrows illustrated by way of example in the exemplary flow paths in FIG. 1a and FIG. 1b indicate exemplary flow directions.

As mentioned, device 200 can be configured such that retentate from a reverse osmosis process 201 can be discharged from device 200 via the exemplary outlets or drains or gullies 202, 203.

As generally described above, the filtration modules or the reverse osmosis modules or the reverse osmosis can be operable independently and controlled individually or in groups.

Controlling the exemplary filtration modules or the filtration blocks or the reverse osmosis modules, respectively, can be effected, for example, in dependence of a filling level of the filling device (for example, measured by a filling level gauge, not shown) and/or in dependence on a predetermined conductance value of the water to be filled.

It is to be understood that the above description is intended to be illustrative, and not restrictive. Many other embodiments will be apparent upon reading and understanding the above description. Although embodiments of the present invention have been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

A list of reference numbers used with reference to FIG. 1a and FIG. 1b is as follows:
100 Exemplary device for treating and filling water;
101 Exemplary water treatment device;
102 Exemplary (first) filtration block;
102a Exemplary filtration module;
102b Exemplary filtration module;
102c Exemplary filtration module;
103 Exemplary (second) filtration block;
103a Exemplary filtration module;
103b Exemplary filtration module;
103c Exemplary filtration module;
104 Exemplary (third) filtration block;
104a Exemplary filtration module;
104b Exemplary filtration module;
104c Exemplary filtration module;
105 Exemplary connection for raw water, exemplary raw water supply;
106 Exemplary shut-off device, exemplary shut-off valve for regulating or interrupting the raw water supply;
107 Exemplary valve, exemplary multi-way valve, exemplary two-way valve;
108 Exemplary valve, exemplary multi-way valve, exemplary two-way valve;
109 Exemplary valve, exemplary multi-way valve, exemplary two-way valve;
110 Exemplary valve, exemplary multi-way valve, exemplary two-way valve;
111 Exemplary valve, exemplary multi-way valve, exemplary two-way valve;
112 Exemplary valve, exemplary multi-way valve, exemplary two-way valve;
113 Exemplary valve, exemplary multi-way valve, exemplary two-way valve;
114 Exemplary valve, exemplary multi-way valve, exemplary two-way valve;
115 Exemplary valve, exemplary multi-way valve, exemplary two-way valve;
116 Exemplary valve, exemplary multi-way valve, exemplary two-way valve;
117 Exemplary valve, exemplary multi-way valve, exemplary two-way valve;
118 Exemplary valve, exemplary multi-way valve, exemplary two-way valve;
119 Exemplary valve, exemplary multi-way valve, exemplary two-way valve;
120 Exemplary flow path, exemplary return path for water not extracted by the filling device, e.g. excess water when the filling device is overfilled or when filling is stopped;
121 Exemplary connection or exemplary flow path, respectively, exemplary direct coupling between the water treatment device and the filling device for feeding/supplying the filling device with treated water, i.e. water that has at least once at least partially passed through the water treatment device;
122 Exemplary supply, or exemplary flow path, for supplying raw water and/or for water that is returned and not extracted by the filling device;
123 Exemplary filling device;
124 Exemplary containers filled by the filling device;
125 Exemplary valve, exemplary multi-way valve, exemplary two-way valve;
126 Exemplary valve, exemplary multi-way valve, exemplary two-way valve;
200 Exemplary device for treating and filling water;
201 Exemplary reverse osmosis module, exemplary reverse osmosis block;
202 Exemplary drain of the reverse osmosis module/reverse osmosis block, e.g. drain for retentate;
203 Exemplary drain of the reverse osmosis module/reverse osmosis block for the discharge of retentate, exemplary gully;
204 Exemplary outflow/outlet of the reverse osmosis module/reverse osmosis block for permeate of the reverse osmosis module/the reverse osmosis block;
205 Exemplary connection or exemplary flow path, respectively, exemplary direct coupling between the water treatment device and the filling device for feeding/supplying the filling device with treated water, exemplary bypass for bypassing the reverse osmosis module/the reverse osmosis block;
206 Exemplary connection or exemplary flow path, respectively, exemplary direct coupling between the water treatment device and the filling device for feeding/supplying the filling device with treated water, i.e. water that has at least once at least partially passed through the water treatment device;
207 Exemplary sensor for measuring the conductance or the electrical conductivity of water;
208 Exemplary sensor for measuring the conductance or the electrical conductivity of water;
209 Exemplary communication connection for control signals;
210 Exemplary communication connection for control signals;
211 Exemplary communication connection for control signals;
212 Exemplary connection for control signals;
213 Exemplary flow path, exemplary return path for water not extracted by the filling device, e.g. excess water when the filling device is overfilled or when filling is stopped;
214 Exemplary multi-way valve, exemplary three-way valve;
215 Exemplary outlet, exemplary flow path for water treated by the filtration modules or by the filtration blocks, respectively;
216 Exemplary flow path;
217 Control unit or part of a control unit.

1.-15. (canceled)

16. A device for treating and filling water, comprising:
a water treatment device with at least one filtration module; and
at least one filling device for filling one or more containers with water treated by said water treatment device, wherein said water treatment device is coupled directly to said at least one filling device.

17. A device according to claim 16, wherein said filling device comprises an intermediate buffer.

18. A device according to claim 17, wherein the intermediate buffer comprises a ring chamber for buffering the water supplied from said water treatment device.

19. A device according to claim 16, wherein said water treatment device comprises a plurality of filtration modules, where said plurality of filtration modules are operable independently of each other.

20. A device according to claim 19, configured such that at least some of said plurality of filtration modules can be at least one of a) cleaned or b) backflushed during operation of said device.

21. A device according to claim 16, wherein the at least one filtration module is configured to perform membrane filtration.

22. A device according to claim 21, wherein the membrane filtration comprises at least one of microfiltration, ultrafiltration or nanofiltration.

23. A device according to claim 16, wherein said water treatment device further comprises at least one reverse osmosis module configured to perform reverse osmosis.

24. A device according to claim 16, further comprising:
at least one filling level gauge configured to measure a water filling level in said filling device, wherein said device is configured to control said water treatment device in dependence of measurements by said at least one filling level gauge.

25. A device according to claim 16, wherein said device is configured to return excess water to said water treatment device when said filling device is overfilled.

26. A method for treating and filling water, comprising:
treating water in a water treatment device with at least one filtration module; and
passing water treated by said water treatment device directly to a filling device for filling one or more containers.

27. A method according to claim 26, further comprising:
using at least one filtration module to perform at least one of microfiltration, ultrafiltration or nanofiltration of the water to be treated.

28. A method according to claim 26, further comprising:
performing reverse osmosis of the water to be treated, before the water is passed directly to said filling device.

29. A method according to claim 26, further comprising:
measuring a conductance of the water before, during and after treatment by said water treatment device.

30. A method according to claim 26, further comprising:
performing at least one reverse osmosis process for the water to be treated by the water treatment device;
performing at least one of a microfiltration process, an ultrafiltration process or a nanofiltration process of the water to be treated;
determining a predefinable conductance value of water to be filled in the one or more containers; and
depending on the predefinable conductance value of the water to be filled, mixing the water filtered by at least one of the microfiltration process, the ultrafiltration process or the nanofiltration process with water from said at least one reverse osmosis process before the treated water is passed directly to said filling device.

31. A method according to claim 26, further comprising:
performing at least one reverse osmosis process in a circulation method.

32. A method according to claim 26, further comprising:
determining a filling level of said filling device; and
depending on the filling level of said filling device, performing at least one of switching on, switching off or controlling one or more individual components of said water treatment device, wherein the one or more individual components comprise at least one of an individual filtration module or an individual reverse osmosis module.

33. A method according to claim 26, further comprising:
returning excess water to said water treatment device when said filling device is overfilled.

34. A method according to claim 26, further comprising:
backflushing one or more filtration modules using a partial flow of at least one of treated water or excess water when said filling device is overfilled.

35. A method according to claim 26, further comprising:
testing an integrity of one or more individual components of said water treatment device by pressurization prior to commissioning the water treatment device, wherein the one or more individual components comprise at least one of an individual filtration module or an individual reverse osmosis module.
